(19) United States
(12) Patent Application Publication
(10) Pub. No.: US 2005/0137941 A1
(43) Pub. Date: Jun. 23, 2005

(54) Image-forming device and method of selling consumables

(75) Inventor: Osamu Fujinawa, Niigata (JP)

Correspondence Address: OLIFF & BERRIDGE, PLC, P.O. BOX 19928, ALEXANDRIA, VA, 22320, US

(73) Assignee: FUJI XEROX CO., LTD., Minato-ku (JP)

(21) Appl. No.: 10/867,677

(22) Filed: Jun. 16, 2004

(30) Foreign Application Priority Data
Dec. 22, 2003 (JP) 2003-424854

(51) Int. Cl. G06F 17/60

(52) U.S. Cl. 705/26

(57) ABSTRACT

An image-forming device in which consumables are consumed by printing of images, comprises a storage unit for storing consumables sales information and a printing unit that prints out the consumables sales information stored in the storage section onto a recording medium.

### BACKGROUND OF THE INVENTION

1. Field of the Invention

The present invention relates to a method of selling consumables used in an image-forming device and to an image-forming device used therein, and in more detail relates to a method of selling consumables and an image-forming device used therein whereby the convenience of a user of the image-forming device when ordering these consumables can be increased.

2. Description of the Related Art

For example, when using a printer, consumables that are consumed by the printing of images, such as toner cartridges, photosensitive drum units and recording paper are required.

It is known that a user support system whereby, when the remaining quantity of consumables of a printer has become insufficient, a user can purchase consumables in accordance with the latest consumables information rapidly and in a simple fashion. This known example assumes purchase of consumables through the Internet (Web) and a connection is effected to the network is a precondition.

Also, it is known that a printer and a method of managing consumables whereby consumables shop can ascertain consumables information such as the rate of use and the amount of stock for consumables without needing to visit the user and so can efficiently perform tasks such as replenishment of consumables. In these known examples, the consumables shop or the user accesses the printer through a client computer using a network connection to acquire the consumables information.

### SUMMARY OF THE INVENTION

The present invention has been made in view of the above circumstances and provides a method of selling consumables that is convenient for ordering consumables by the user of an image-forming device, and have high cost performances for advertisement of the consumables for both manufacturer and seller. The present invention also provides an image-forming device used in the method of selling consumables.

One aspect of the present invention provides an image-forming device using consumables that is consumed by printing of images, and comprising storage unit that stores consumables sales information; and a printing unit that prints out the consumables sales information stored in the storage unit onto a recording medium.

Another aspect of the present invention provides a method of selling consumables in which a manufacturer manufactures an image-forming device and consumables used in the image-forming device, and a seller sells the image-forming device to a user and then sells to the user the consumables used in the image-forming device that the seller sold to the user, wherein the manufacturer manufactures the image-forming device comprising a storage unit and a printing unit that prints out consumables sales information stored in the storage unit onto a recording medium; the manufacturer or the seller stores the consumables sales information in the storage unit of the image-forming device; and the seller sells to the user the image-forming device in which the consumables sales information is stored, receives an order for the consumables that is placed by the user who purchased the image-forming device in accordance with the consumables sales information printed out by the image-forming device, and sells to the user the consumables for which the order has been received.

With the above configurations, ordering of the consumables by the user is facilitated since the order for the consumables can be created using the consumables sales information that has thus been printed out when the user prints out the consumables sales information using this image-forming device after purchasing the image-forming device.

### BRIEF DESCRIPTION OF THE DRAWINGS

Preferred exemplary embodiments of the present invention will be described in detail based on the following drawings, wherein:

FIG. 1 is a block diagram illustrating the functional configuration of a printer according to an embodiment of the present invention;

FIG. 2 illustrates a method of storing consumables sales information in the printer by a manufacturer;

FIG. 3 illustrates a method of storing consumables sales information in the printer by a seller;

FIG. 4 illustrates an example of the environment in which the printer is used by a user;

FIG. 5 is a flow chart illustrating the operation of printing consumables sales information by the printer according to embodiment of the present invention;

FIG. 6 illustrates a first example of the results of output of consumables sales information;

FIG. 7 illustrates a second example of the results of output of consumables sales information;

FIG. 8 illustrates a third example of the results of output of consumables sales information;

FIG. 9 is a diagram illustrating the flow of sale of consumables using the printer according to embodiment of the present invention;

FIG. 10 illustrates the transaction flow of a first business model employing the method of selling consumables according to embodiment of the present invention; and

FIG. 11 illustrates the transaction flow of a second business model employing the method of selling consumables according to embodiment of the present invention.

### DESCRIPTION OF THE PREFERRED EMBODIMENTS

Preferred exemplary embodiments of the present invention are described in detail below with reference to the accompanying drawings.

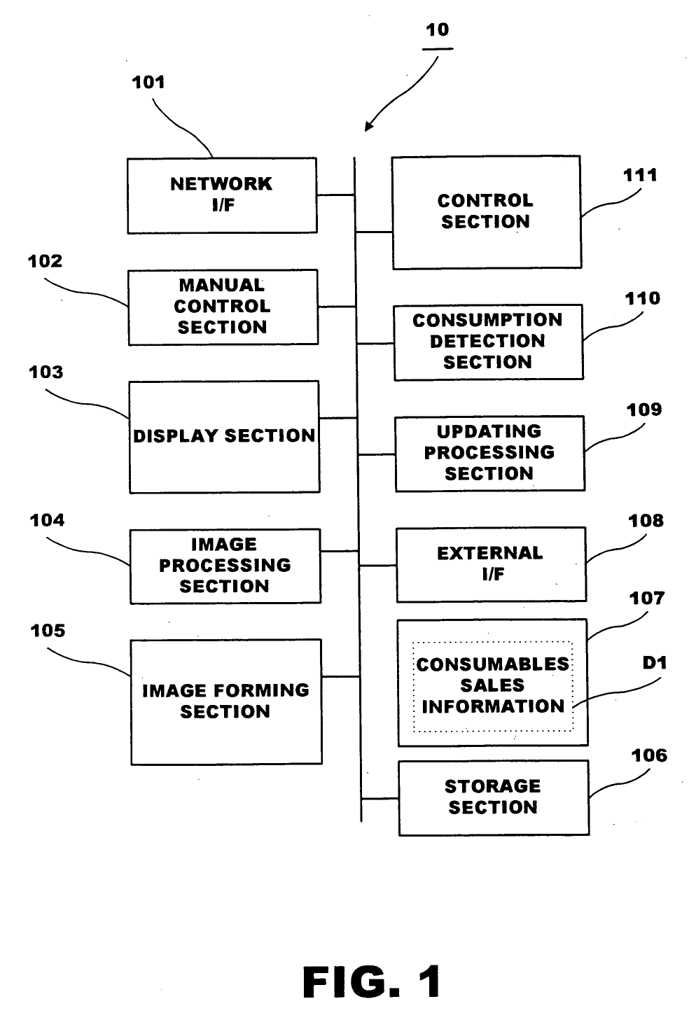

FIG. 1 is a block diagram illustrating the functional configuration of a printer 10 according to an embodiment of the present invention.

The printer 10 comprises a network interface (I/F) 101 that controls interfacing with the network, a manual control section 102 that performs control relating to, for example, input of various types of information and issue of various types of command, a display 103 that displays various types of information, an image processing section 104 that performs image processing in which printing data is generated from image information of a printable object, an image forming section 105 that forms an image on a recording medium corresponding to printing data generated by image processing by the image processing section 104, a storage section 106 that stores various types of information such as an operating program, consumables sales information storage section 107, an external interface (I/F) section 108 that controls interfacing with external equipment such as a dedicated tool 17, to be described, an updating processing section 109 that performs updating processing of the consumables sales information stored in the consumables sales information storage section 107, a consumption detection section 110 that detects the state of consumption of the various types of consumables used in the printer 10, and a control section 111 that performs control of this entire printer.

As consumables that are consumed by the image printing and by the image forming section 105, the printer 10 employs, for example, a toner cartridge, a photosensitive drum unit and recording paper.

The consumables sales information storage section 107 stores consumables sales information (D1) relating to sale of various types of consumables consumed by the printing operation of the printer 10.

The consumables sales information storage section 107 comprises a non-volatile memory such as a flash ROM, EEPROM or HardDisk in which information can be rewritten.

The control section 111 reads consumables sales information from the consumables sales information storage section 107 in response to a prescribed printing start-up command, such as a printing command corresponding to a prescribed control action at the manual control section 102 and controls the image forming section 105 to deliver printed output onto the recording medium by image processing by performed the image processing section 104.

In the printer 10, the consumables sales information stored in the consumables sales information section 107 is information relating to the sales details of consumables used by the printer 10 such as the name of the shop, address, contact details, i.e., telephone number, fax (facsimile device) number, e-mail address, homepage address (Web address) of the seller that sells the printer 10, the name of the consumables, the name of the type of printer, the corresponding consumables model number, the cost, information as to the remaining amount of the consumables, and sales promotion information such as advertising information for promoting consumables sales by this seller.

The consumables sales information comprising the above information items is stored in the consumables sales information storage section 107 of the printer 10 by this manufacturer when the manufacturer manufactures and ships the printer 10.

The printer 10 in which the consumables sales information has been stored in the consumables sales information storage section 107 by the manufacturer is then sold to the user through the seller.

In this case, the consumables sales information stored in the consumables sales information storage section 107 of the printer 10 when shipped by the manufacturer is information relating to the sale of consumables by the seller who sold the printer 10 under a commission from the manufacturer, for example.

That is, the information as to the shop name, address and contact details in the consumables sales information stored in the consumables sales information storage section 107 consists of the various items of information of the seller who sold the printer 10.

In the printer 10, the consumables sales information stored in the consumables sales information storage section 107 is printed out onto a recording medium under control exercised by the control section 111 described above.

In this case, depending on the layout of the consumables sales information that is to be printed, for example, the shop name, address, contact details, consumables name, and advertising information of this seller who sold the printer 10 are printed on the recording medium.

By referring to the contact details information printed on the storage medium, the user can communicate with this seller and can place an order with the seller, by selecting the desired consumables in reference to the information such as the consumables name that is printed together therewith.

As mentioned above, the printed contact details information is information as to the contact details of the seller's shop where the printer 10 was sold.

It is therefore very convenient for the user of the printer 10 to place an order for the consumables of the printer 10 with the seller where the printer 10 was purchased, by using this contact details information.

On the other hand, the seller is able to induce users to select the seller's company as one of the possible sources for ordering consumables through the consumables ordering operation by the user who purchased the printer 10 from the seller's company based on the printout of consumables sales information as described above, whereby the seller's competitiveness in regard to other sellers can be improved.

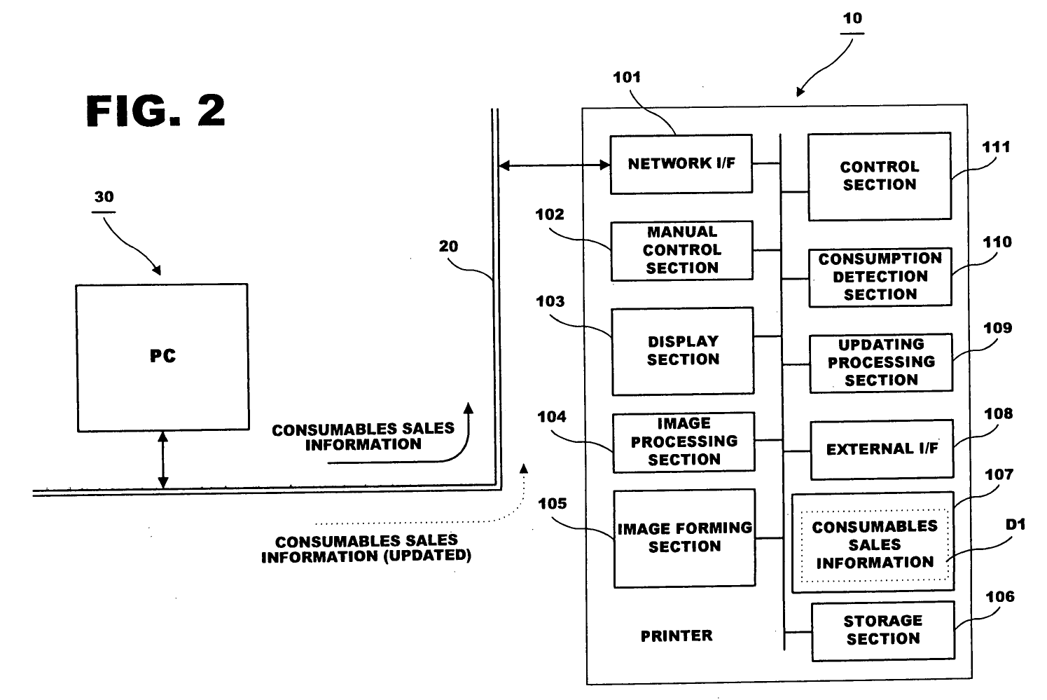

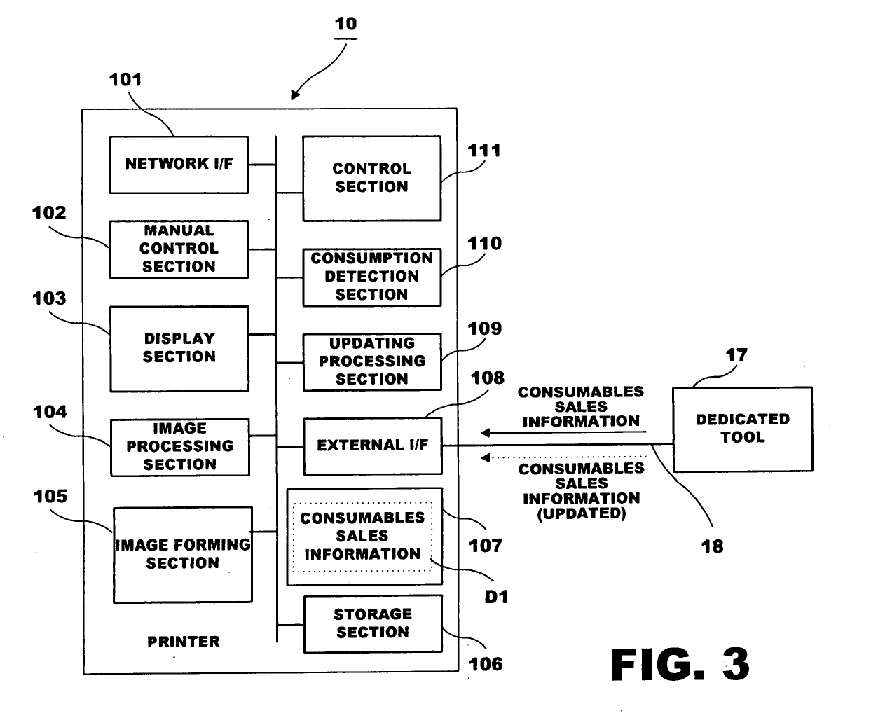

In order to store the consumables sales information in the consumables sales information storage section 107 of the printer 10 according to present invention, the methods shown in FIG. 2 and FIG. 3 may be adopted.

FIG. 2 shows an example of operations for writing consumables sales information in online through a network 20 to the consumables sales information storage section 107, using a PC (personal computer) 30, when manufacturing and shipping the printer 10 by the manufacturer of the printer 10.

In this operations, the manufacturer collects from the seller who sold the printer 10 consumables sales information comprising, for example, the shop name of this seller, the contact details information, information as to the consumables dealt with by this seller or advertising information, and writes the consumables sales information in online into the consumables sales information storage section 107.

As a method of writing consumables sales information by utilizing an interface with a host device (PC 30), apart from online writing by a network as described above, writing could be performed using a USB or parallel port. It is also possible to write the consumables sales information using a dedicated application running on the PC 30.

It should be noted that the operations described above of writing consumables sales information by utilizing an interface with a host device (PC 30) could also be applied when updating the consumables sales information written by these operations.

In the updating processing, updating details (consumables sales information to be updated) are sent together with an updating request through the various types of interface described above (USB, parallel port, or via a network) from the PC 30.

When the printer 10 receives the updating request and updating details transmitted from the PC 30, the updating processing section 109 is started up in response to the updating request, and processing is performed to update the consumables sales information stored in the consumables information storage section 107 in accordance with the updating details received together with the updating request.

FIG. 3 shows an example of writing consumables sales information to the consumable sales information storage section 107 using a dedicated tool 17 having a processing function of writing consumables sales information by the seller who sold the printer 10 manufactured by a manufacturer to the user under a commission from the manufacturer.

In this case, when the manufacturer ships the printer 10 to the commissioned seller, the manufacturer provides the dedicated tool 17 (separately provided for each shipping destination) to the seller.

In turn, the seller connects the dedicated tool 17 provided by the manufacturer with the external I/F 108 through a communication cable 18 and writes the consumables sales information in respect of consumables sales by the seller's company to the consumables sales information storage section 107 using the dedicated tool 17.

It should be noted that the method of writing consumables sales information using the dedicated tool 17 could also be applied when updating the consumables sales information that was written by this method.

In such updating processing, the details to be updated (consumables sales information to be updated) are sent together with an updating request from this dedicated tool 17 in a condition with this dedicated tool 17 connected to the printer 10 in the mode described above.

In response thereto, when the printer 10 receives this updating request and updating details sent from the dedicated tool 17, the updating processing section 109 is started up in response to this updating request and processing is performed to update the consumables sales information already stored in the consumables information storage section 107 with the updating details received together with this updating request.

As described above, the printer 10 in which the consumables sales information is stored by the manufacturer (see FIG. 2) or the seller (see FIG. 3) is then sold from this seller to the user.

After purchasing the printer 10 from the seller and commencing use thereof, the user can print out onto a recording medium the consumables sales information (stored in the consumables sales information storage section 107) using the consumables sales information printing function described above which is provided in the printer 10.

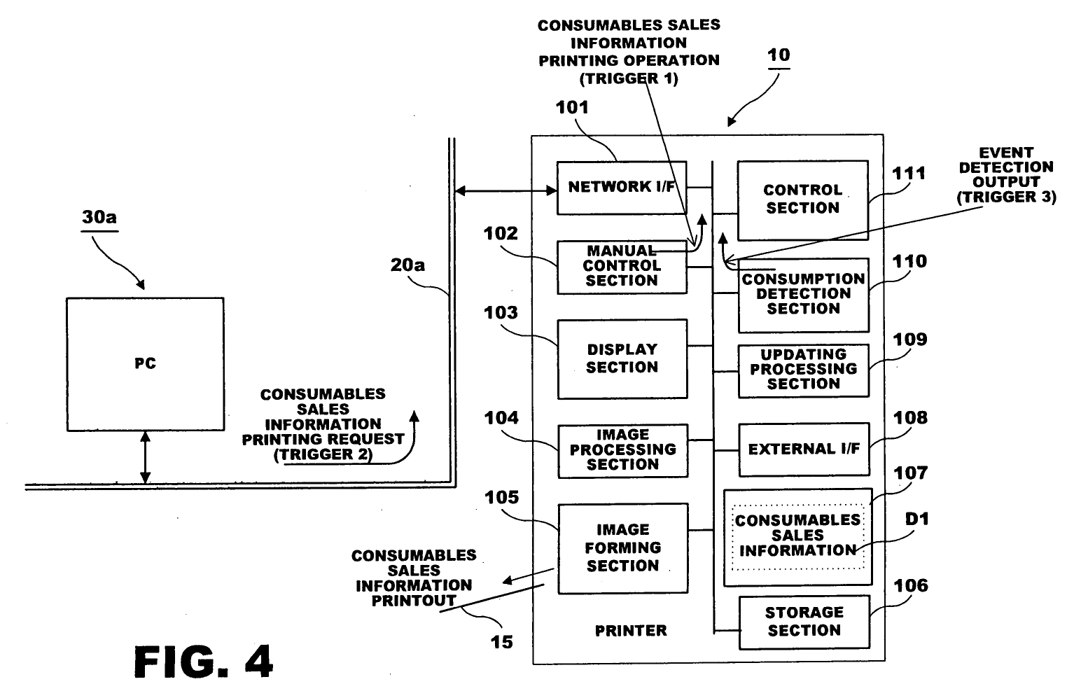

FIG. 4 shows an example of the environment in which the user uses the printer 10.

In FIG. 4, the printer 10 is connected with a PC 30a (PC used by a user) through a network 20a by means of a network I/F 101.

In this condition, the user can print document information generated by various types of application on the PC 30a by sending this document information to the printer 10 by issuing printing commands with the properties of the printer driver.

In the printer 10 in such an environment of use, in order to print the consumables sales information, there are available, for example, the method of starting up printing triggered by an input command (trigger 1) in response to a specified manual control operation performed using the manual control section 102 by the user himself, the method of starting up printing triggered (trigger 2) by a printing request issued through the network 20a from this PC 30a in response to a manual operation of the PC 30a (host device) performed by the user himself, and the method of starting up printing automatically by the printer 10 triggered by (trigger 3) output of detection of an event relating to the state of consumption of the consumables by a consumption detection section 110 of the printer 10.

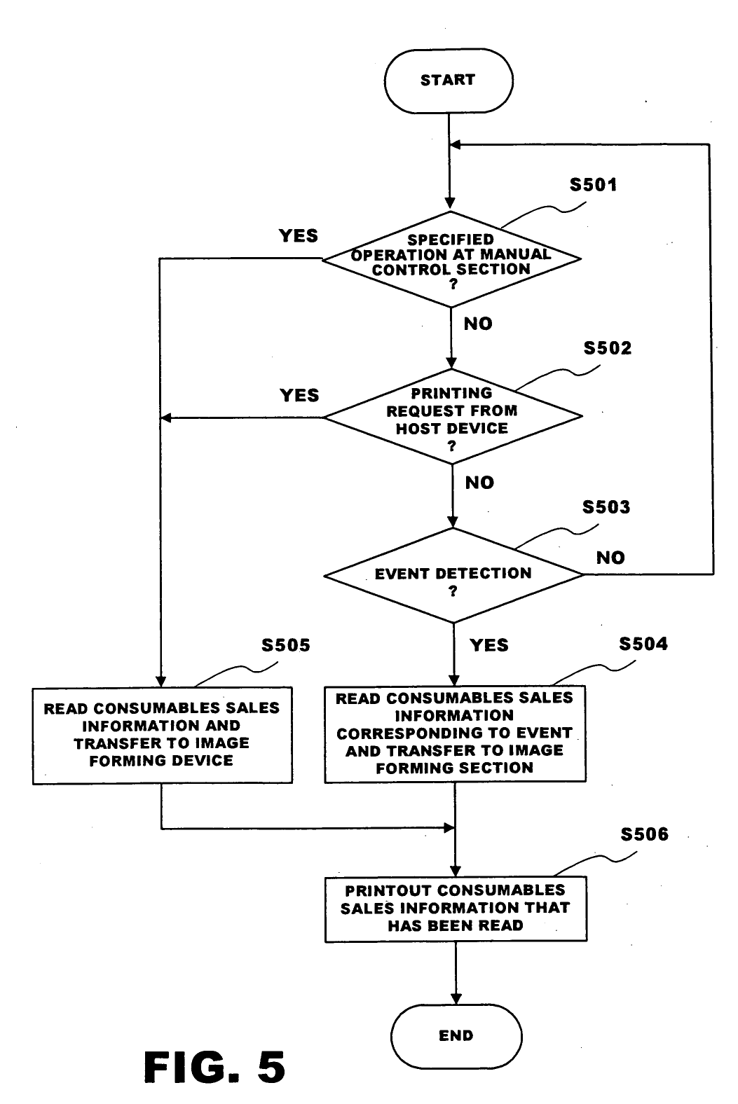

Consumables sales information printing operation using these three methods of starting up printing with the printer 10 will now be described with reference to the flow chart shown in FIG. 5.

As shown in FIG. 5, in the printer 10, the control section 111 checks (step S501) to ascertain whether or not a specified control operation (switch operation) has been performed at the manual control section 102.

The specified control operation that is the subject of this checking is, for example, a predetermined switch operation to give a command for printing the consumables sales information, such as, for example, independent operation of a given specified switch (consumables sales information printing switch) or a combined operation of a plurality of switches.

If, at this point, the specified control operation has not been performed (step S501 NO), the control section 111 then checks to ascertain whether or not a request for printing the consumables sales information has been issued from the PC 30a (step S502).

Further, if no such request for printing the consumables sales information has been made (step S502 NO), the control section 111 then checks to ascertain whether or not an event relating to the condition of consumption of the consumables has been detected by the consumption detection section 110 (step S503), such as, for example, insufficiency of the remaining amount of toner or contamination of the drum cartridge.

Thereupon, if no such event has been detected (step S503 NO), the control section 111 returns to step S501 and continues checking processing of the steps S501 to S503.

In this process, in step S501 above, if a specified control operation is performed at the manual control section 102 (step S501 YES), the control section 111 reads (step S505) the consumables sales information from the consumables sales information storage section 107 and transfers this information to the image processing section 104.

The image processing section 104 generates printing data by image processing of this consumables sales information and sends this printing data to the image forming section 105.

The image forming section 105 prints the consumables sales information corresponding to this printing data on the recording medium 15 in accordance with the printing data sent from the image processing section 104 and discharges this recording medium 15 (step S506).

Also, in the above step S 502, if a request for printing the consumables sales information is input from the PC 30a (step S502 YES), the control section 111, if a specified control operation is performed at the manual control section 102 (step S501 YES) performs processing in the same way as hereinbelow.

In this case, the control section 111 exercises control so as to read the consumables sales information (step S505) from the consumables sales information storage section 107 and print out (step S506) this consumables sales information onto the recording medium by means of the image forming section 105, by image processing performed by the image processing section 104.

Also, in the above step S503, if an event relating to the consumption condition of the consumables such as insufficiency of the remaining amount of toner is detected by the consumption detection section 110 (step S503 YES), the control section 111 reads the consumables sales information (step S504) corresponding to this detected event from the consumables sales information storage section 107 and transfers this consumables sales information to the image processing section 104.

The image processing section 104 generates printing data by performing image processing on this consumables sales information and sends this printing data to the image forming section 105.

The image forming section 105 prints the consumables sales information corresponding to this printing data on the recording medium 15 in accordance with the printing data sent thereto from the image processing section 104 and discharges this recording medium 15 (step S506).

In this way, the printer 10 according to the present embodiment can print consumables sales information on a recording medium 15 by going through the processing shown in FIG. 5.

The results of printing out the consumables sales information will be further described in detail below with regard to some specific examples.

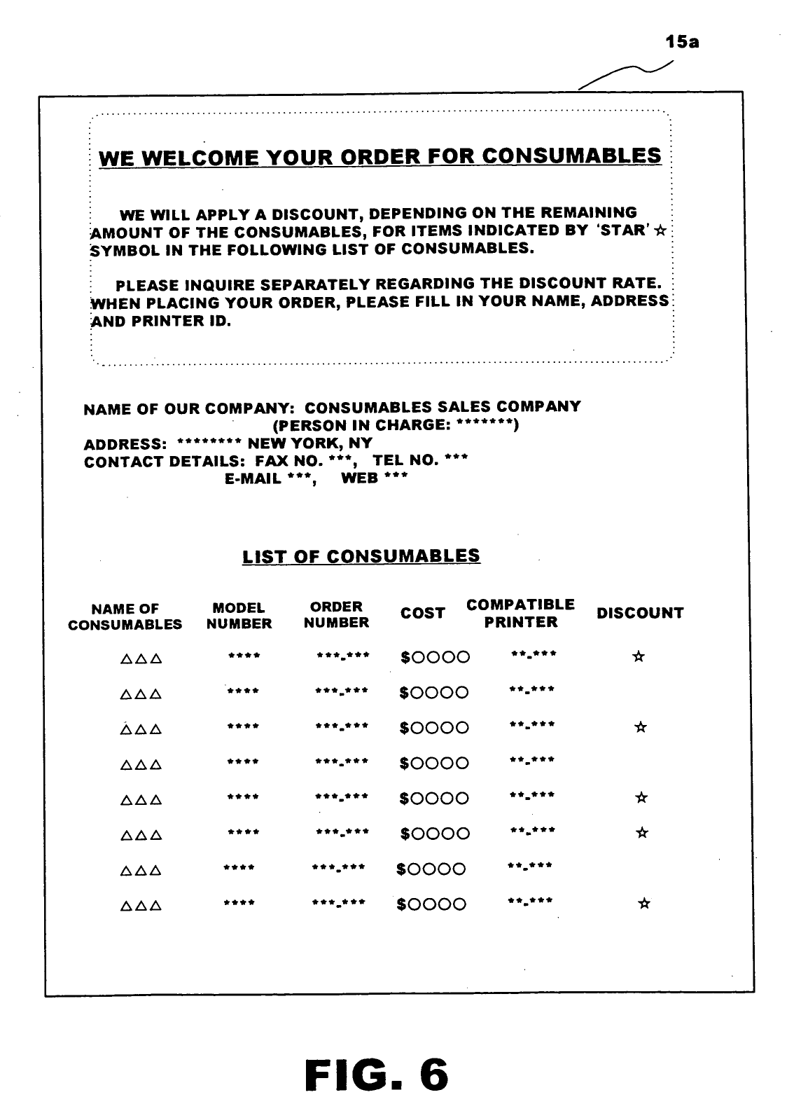

FIG. 6 illustrates a first example of the results of outputting consumables sales information.

On the recording medium 15a constituting the output results in this example, as the consumables sales information, there are printed advertising information promoting purchase of the consumables (section enclosed by the dotted line), various items of information such as the company name, address, and contact details of the seller who sells the consumables and consumables list information comprising various items such as the consumables name, model number, order number, cost, compatible printer types and discount of the consumables sold by this seller.

Using the recording medium 15a on which the consumables sales information with the above details has been printed, the user selects, for example, the desired consumables required for the printer 10 which the user is currently using from the printed list of consumables and can thus order this consumables from the seller using, for example, fax, telephone, e-mail or the Web, based on the contact details information (fax number, telephone number, e-mail address, Web address etc).

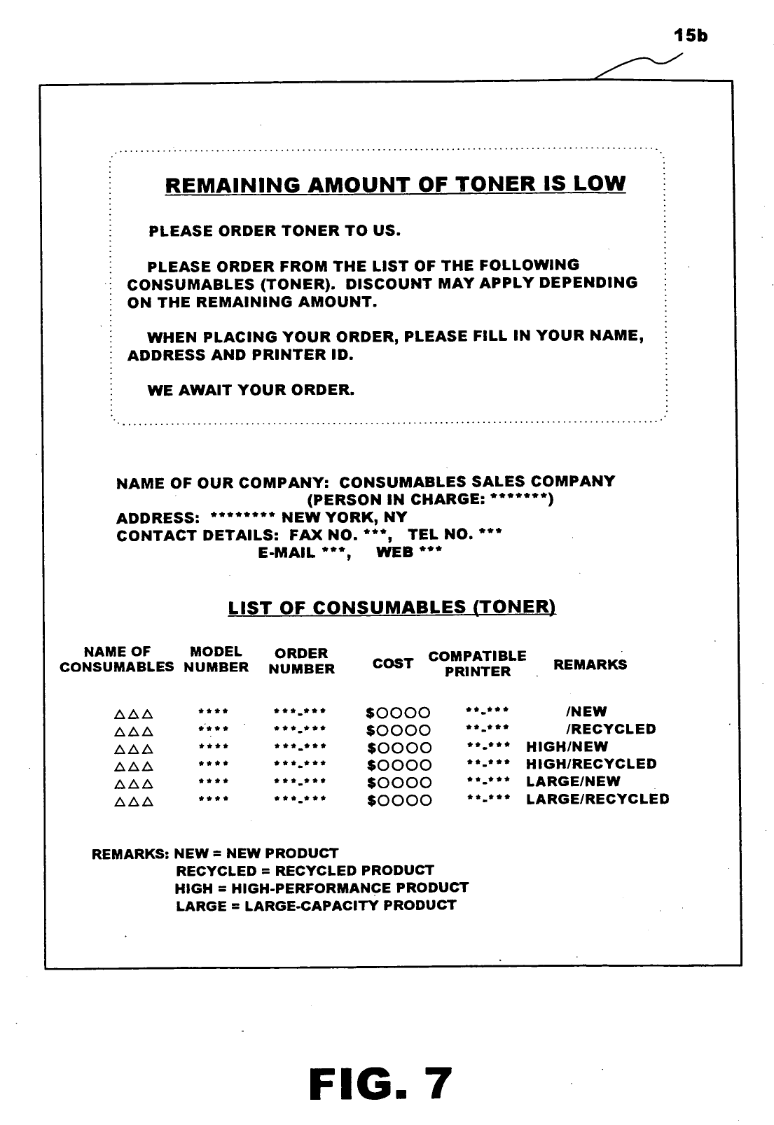

FIG. 7 illustrates a second example of the results of output of the consumables sales information.

This second example corresponds to the results of printing and output of consumables sales information read (step S504 in FIG. 5) from the consumables sales information storage section 107, for example, in response to event detection of insufficiency of the remaining amount of toner by the consumption detection section 110 (YES in step S503 in FIG. 5).

On the recording medium 15b which is the result of output in this example, consumables sales information is printed, including notification information (section within the dotted line) to the effect that the remaining amount of toner is low and prompting purchase of toner, various items of information such as the company name, address and contact details of the seller who sells the toner, and list information of consumables (toner) sold by this seller.

Apart from information as to the consumables name, model number, order number, cost, and compatible printer types, the item information in the consumables list includes information for indicating whether this consumables is a new product, old stock, recycled product, high-performance product, small-capacity product or large-capacity product.

Using the recording medium 15b on which the consumables sales information with the above details has been printed, the user is able to ascertain whether the remaining amount of toner has become low by checking the above notification information, and can immediately determine whether it is necessary to order more toner.

Furthermore, the various types of toner that are applicable to the printer 10 that is currently used by the user are printed in the form of consumables (toner) list on this recording medium 15b.

In this way, after the user has selected the desired type of toner, such as new product, old stock, recycled product, high-performance product, small-capacity product or large-capacity product from the consumables (toner) list, the user can order this consumables of from the seller using, for example, fax, telephone, e-mail or the Web, based on the contact details information (fax number, telephone number, e-mail address, Web address etc).

In this case, the user can select the toner to be ordered from new products, old stock, recycled products, high-performance products, small-capacity products or large-capacity products also taking price into account so that the choice of consumables that can be ordered is wider than in the case of the first example.

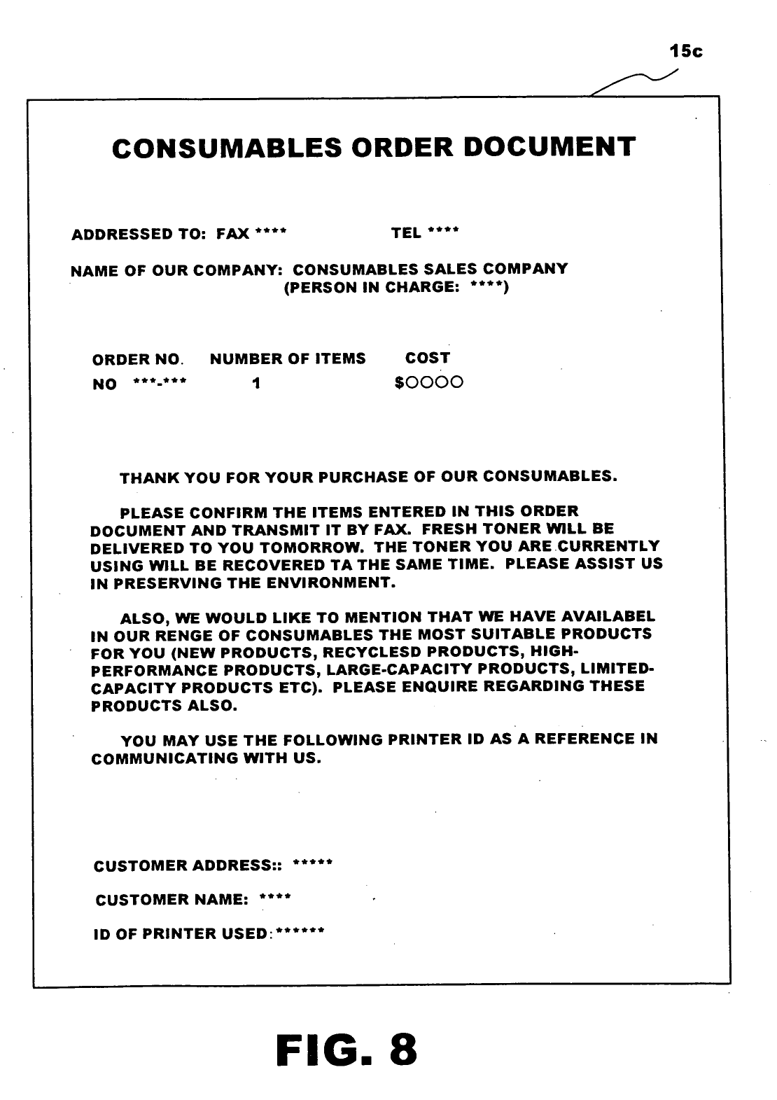

FIG. 8 illustrates a third example of the results of output of consumables sales information.

In this third example, the consumables sales information is printed out onto a recording medium in the form of consumables order document for fax transmission, for example.

On the recording medium 15c which is the result of output in this example, as the consumables sales information, there is printed information such as boxes to be filled in of header information of the consumables order document, address information of the consumables order destination for fax transmission [company name and fax number and telephone number of the seller (i.e. the seller who sold the printer 10) who sells the consumables], notification information including boxes to be filled in representing the details of the order (order number, number of items, cost) and ordering sequence or notification details, and various items of information relating to the issuer of the order (the user) and the printer used (the printer 10 in question) (the customer's address, name and ID) of the printer used).

Using the recording medium 15c on which is printed the consumables sales information with the above content (consumables order document), after entering in the appropriate respective boxes of this consumables order document the order number of the desired consumables, the number of items, the cost and the user's own address, name, and ID of the printer 10 used, the user can place an order for the desired consumables extremely easily simply by fax transmission of this consumables order document to the corresponding fax number.

In all of the first to the third examples, the consumables sales information that is printed out on the recording media 15 (15a, 15b, 15c) includes various items of information such as the company name and contact details of the seller who sold the printer 10 that delivered this printed output, consumables name, name of the type of printer, and model number of the applicable consumer product.

The user can therefore order from the seller where the user purchased the printer 10 the desired consumables using the contact information printed on the recording medium 15 while viewing this information printed thereon.

If the recording medium 15c according to the third example is used, the ordering process can be greatly simplified, since this can be simply transmitted by fax as an order document to the seller.

Furthermore, the competitiveness of the seller in regard to other sellers can be increased, since the user who purchased the printer 10 sold by the seller's company can be clearly made aware of the seller's company as a possible choice for ordering of consumables by this user, by means of the consumables information that is printed out by means of the printer 10.

A method of selling consumables according to the present embodiment based on the above-described construction and mode of use of the printer 10 is described below.

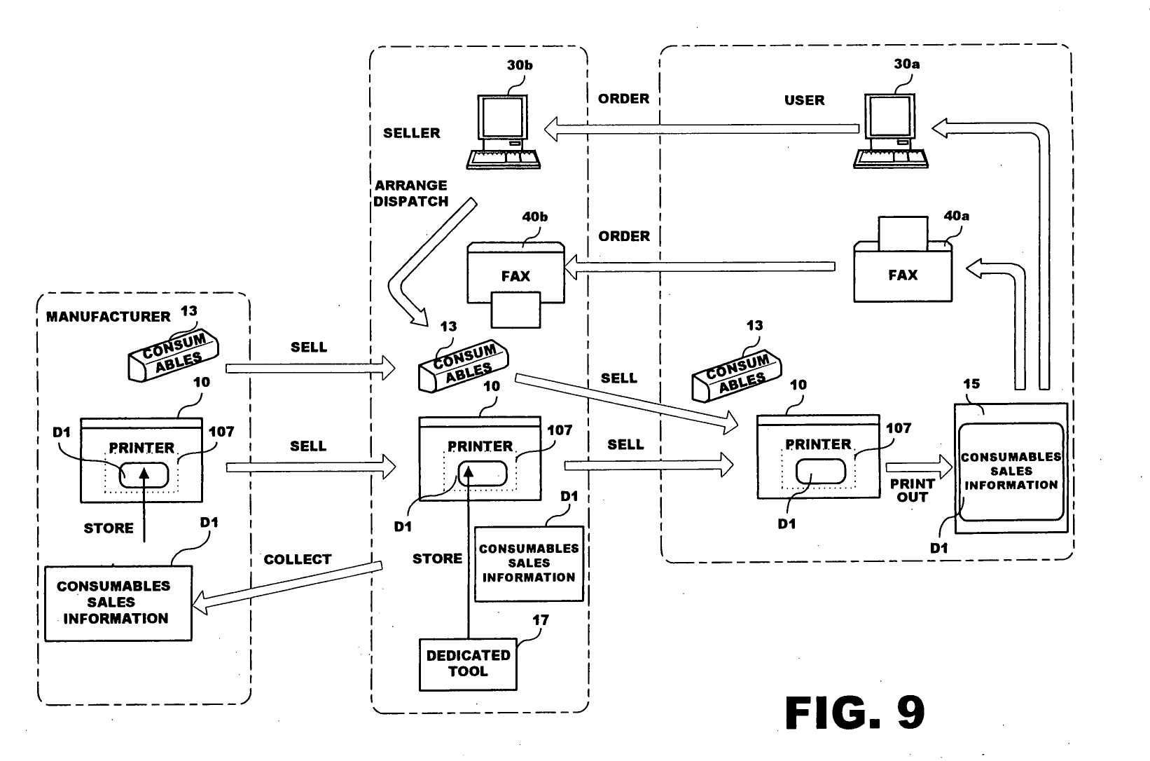

FIG. 9 illustrates the flow of sale of consumables using a printer 10 according to the present embodiment. It should be noted that, although only a single seller is mentioned in FIG. 9, there could be a plurality of sellers.

As shown in FIG. 9, in selling consumables according to the present embodiment, the manufacturer who manufactures the printer 10 and the various types of consumables 13 (toner etc) used by the printer 10 and the seller who sells printers 10 and consumables manufactured by this manufacturer co-operate in selling to the user of consumables used by the printer 10.

As described above, a printer 10 manufactured by the manufacturer comprises consumables sales information storage section 107 that stores consumables sales information D1 including, for example, the contact details of the seller, the seller's sales advertising for consumables and a list of consumables handled by the seller, and also a printing function that prints out this consumables sales information D1 onto a recording medium 15.

In sales of the consumables, in a method as indicated, for example, in FIG. 2, the manufacturer, when manufacturing and shipping the printer 10, stores consumables sales information D1 online in the consumables sales information storage section 107 before selling the printer 10 to the seller.

In performing this, the manufacturer collects beforehand information such as the company name and contact details from the seller and the necessary information for selling the consumables and uses this collected information to create the consumables sales information D1, which is then stored.

The manufacturer manufactures various types of consumables 13 that are used by the printer 10 and sells these consumables to the seller in response to orders from the seller.

The seller purchases from the manufacturer printers 10 in which there is recorded consumables sales information D1 relating to sale of consumables including the contact details of the seller's company, and sells these printers 10 on to the user.

It should be noted that the task of storing the consumables sales information D1 in the consumables sales information and storage section 107 of the printer 10 described above need not be performed by the manufacturer. It could be performed by the seller itself.

In this case, the manufacturer provides to the seller on shipping of the printer 10 a dedicated tool 17 for consumables sales information storage processing and the seller, using the dedicated tool 17, by, for example, the method shown in FIG. 3, stores the consumables sales information D1 of the seller's company in the consumables sales information storage section 107 of the printer 10.

In this way, after the seller has sold to the user a printer 10 in which is stored the consumables sales information D1 in the consumables sales information storage section 107 by either the manufacturer or the seller, the seller can expect orders for consumables 13 to be placed using the consumables sales information D1 printed out by the user to whom the sale was made using the printer 10.

The user performs printing using the printer 10 purchased from the seller, and, during the course of such use, reads the consumables sales information D1 from the consumables sales information storage section 107 using, for example, a printing start-up command corresponding to the triggers 1 to 3 shown in FIG. 4 and prints out this consumables sales information D1 onto the recording medium 15 (see, for example, 15a, 15b and 15c shown in FIG. 6, FIG. 7 and FIG. 8).

The user then places an order for the desired consumables 13 as required with the seller, while viewing the consumables sales information D1 printed on this recording medium 15.

If the consumables sales information D1 is printed in a mode such as on a recording medium 15a as shown in FIG. 6, the user can access the seller's PC 30b from a PC 30a (or may communicate by telephone) using this contact details information (for example e-mail address or Web address) and order from the seller the desired consumables 13 selected from the consumables list that is simultaneously printed.

Also, if the consumables sales information D1 is printed on a recording medium 15 (15c) in the form of consumables order document as shown in FIG. 8, the user can order the consumables 13 by entering the desired order details (order number and number of items and cost etc of the consumables 13) in this consumables order document and transmitting this form by fax, from a fax 40a, to the fax 40b of the seller, which is given in this order document.

In this regard, when the seller, as described above, after selling the printer 10 to the user, receives an order for consumables 13 by telephone, URL or fax based on the consumables sales information D1 that was printed out to the recording medium 15 by the user using the printer 10, the seller is able to make arrangements for dispatch of the consumables 13 that has thus been ordered and sell this consumables 13 to the user.

As described above, with the method of selling consumables according to the present embodiment, since the consumables sales information relating to sale of the consumables that is handled by this seller is stored in the printer 10 that is sold to the user by the seller, the user can place an order for the consumables using the consumables sales information that is printed out by the printer 10, thereby increasing convenience of ordering consumables for the user, without requiring, for example, access to the Internet.

Also, the seller can induce a user who purchased a printer 10 from this seller to place orders for consumables to this seller using this consumables sales information that is printed out, through the printing and output of the consumables sales information by the printer 10; in this way, competitiveness of the seller with respect to other sellers can be improved and sales promoted.

Furthermore, the manufacturer can expect a considerable increase in profitability by increasing the amount of sales of the consumables manufactured by the manufacturer in response to promotion of sales of the consumables by the seller.

It should be noted that it is desirable that the content of the consumables sales information that is printed by the user using the printer 10 purchased from the seller's company should be a content such as to facilitate ordering from the seller's company, in order to achieve firmer tying-in of users by the seller.

Consumables sales information satisfying this condition should be structured so as to promote feelings of a human relationship by emphasizing recency and appealing to users' emotion, or by increasing the costs of switching to other sellers, for example.

From this point of view, in the present invention, the following expedients may be adopted regarding the content of the consumables sales information.

For example, where the consumables is toner, the consumables sales information employed according to the present embodiment may offer a discount depending on the remaining amount of toner, so as to achieve the advantage of the “first move” in consumables replacement (see FIG. 7).

Also, by specifying the consumables purchase point, barriers to ordering by the user are lowered (see FIG. 6, FIG. 7 and FIG. 8).

Also, by arranging for notification of the model number, opportunities for choice can be provided to the user, such as facilitating the provision of clearance products (recycled products, old stock) for other compatible printers, or provision of the latest toner (new product) (see FIG. 7).

As can be seen from the results of printout of consumables sales information shown in FIG. 6 to FIG. 8, and since the consumables sales information stored in the consumables sales information at storage section 107 of the printer 10 according to the present embodiment includes advertising information promoting purchase of consumables from the seller's company, the seller who sold the printer 10 can treat the consumables sales information storage section 107 in which the advertising information is stored as a kind of advertising space.

From this point of view, as a business model (first business model) employing the method of selling consumables according to the present embodiment, the model that the manufacturer sells (i.e., provides for a consideration) an advertising space corresponding to the consumables sales information storage section 107 of the printer 10 to the seller can be also envisaged.

Also, taking into consideration the fact that the manufacturer provides the seller with the dedicated tool 17 whereby the seller itself can write/update (see FIG. 3 and FIG. 9) advertising information (consumables sales information) in the consumables information storage section 107 (advertising space) of the printer 10, a business model (second business model) is also envisageable in which the dedicated tool 17 for writing the seller company's own advertising information is sold to the seller by the manufacturer (provided for a consideration) in a form requiring, for example, a commitment to a sales number of printers 10.

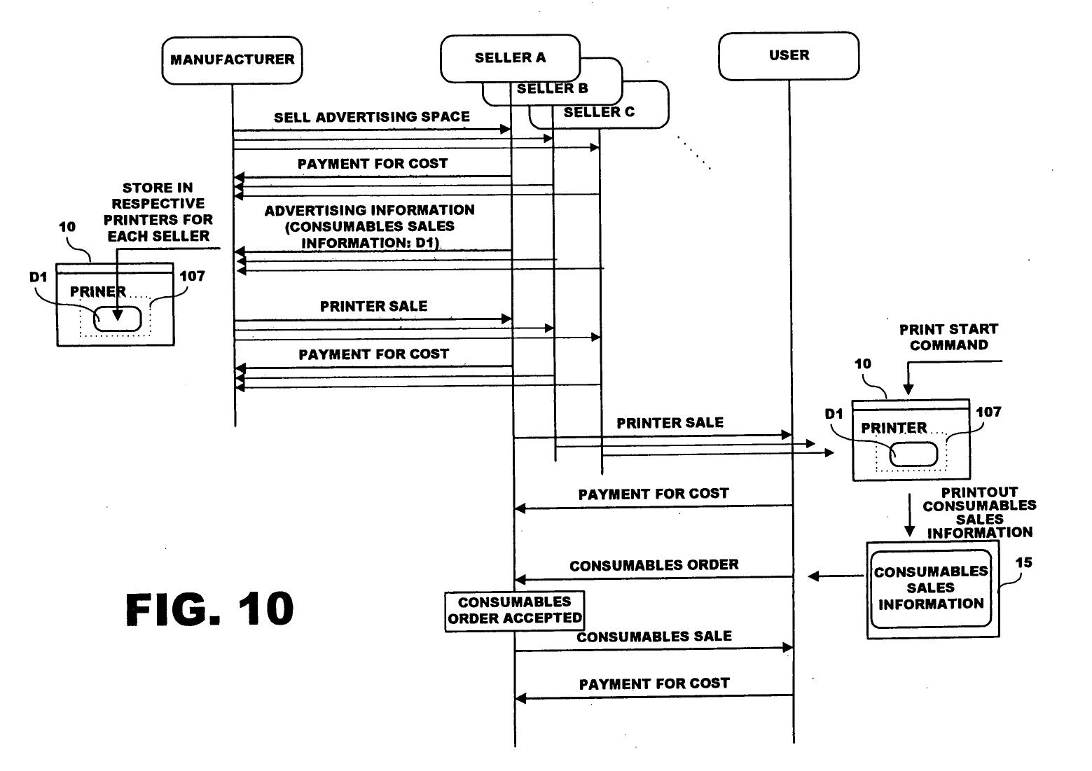

FIG. 10 illustrates the transaction flow in the above first business model.

In FIG. 10, the manufacturer sells the consumables sales information storage section 107 of the printer 10 manufactured by the manufacturer's company to the various sellers A, B, C as advertising space, and obtains payment for the cost therefor.

Also, the manufacturer collects respective advertising information (consumables sales information) from the sellers A, B, C (see FIG. 3 and FIG. 9) to whom the advertising space is sold and ships (sells) the corresponding printers 10 to the sellers A, B, C after storing this information in the consumables sales information storage section 107 of the printers 10 destined for the respective sellers, and obtains payment for the cost therefor.

The sellers A, B, C sell the printers 10 purchased from the manufacturer to the users. The sellers A, B, C then respectively receive orders for consumables placed using the consumables sales information printed out by the users to whom the printers are sold, using the users' own printers 10; the flow of sales of these consumables to the users is as described in FIG. 9.

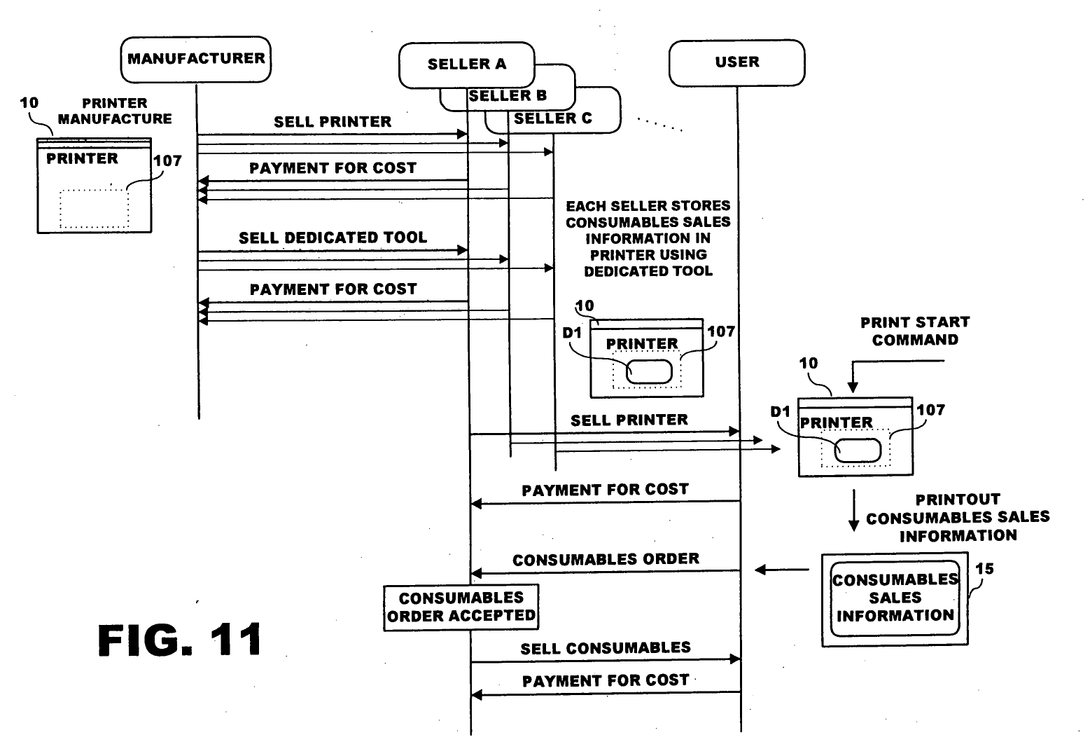

FIG. 11 illustrates the transaction flow in the second business model referred to above.

In FIG. 11, the manufacturer manufactures the printers 10 having an advertising space (consumables information storage section 107) and a function of printing out advertising information (consumables sales information) stored in this advertising space and ships (sells) these to the sellers A, B, C and obtains payment for the cost therefor.

Also, the manufacturer sells to the sellers A, B, C a dedicated tool 17 for writing (including updating) advertising information (consumables sales information) into this advertising space of the printer 10 (consumables information storage section 107) when these printers 10 manufactured by the manufacturer's company are shipped, and obtains payment for the cost therefor.

The sellers A, B, C respectively write advertising information (consumables sales information) using the dedicated tool 17 purchased from this manufacturer into the advertising space (consumables sales information storage section 107) of the printers 10 purchased from the manufacturer before selling these printers 10 on to the users.

The sellers A, B, C then respectively receive orders for consumables placed using the consumables sales information printed out, by the users to whom the printers are sold, using the users' own printers 10; the flow of sales of these consumables to the users is as described in FIG. 9.

Thus, according to the present embodiment, by providing advertising space in local printing by the printers 10, for example, by selling the advertising space only to a number of company customers such as large-scale sellers (i.e. “partners”), the sales competitiveness of such customers can be increased, thereby promoting sales of printers 10 manufactured by the manufacturer's company.

In this way, the manufacturer may also expect increased profitability due to sales of the advertising space or dedicated tool 17.

Apart from this, the present invention is not restricted to the embodiments described above and may be put into practice in suitably modified ways without altering its gist.

For example, in the above embodiments, as the consumables sales information stored in the consumables sales information storage section 107 of the printer 10, an amount thereof corresponding to one page of an A4 size recording medium 15 is envisioned.

However, the consumables sales information is not restricted to the aforementioned amount and the content thereof is also not restricted to the content shown in FIG. 6 to FIG. 8.

Also, the consumables to be sold are not restricted to the toner mentioned in the above embodiments (in fact, what is sold is a toner cartridge) and various types of consumables such as photosensitive drum units or recording paper may be envisioned.

1. An image-forming device using consumables that is consumed by printing of images, comprising:
a storage unit that stores consumables sales information; and
a printing unit that prints out onto a recording medium the consumables sales information stored in the storage unit.

2. The image-forming device according to claim 1 further comprising a manual control unit by which various types of command are inputted,
wherein the printing unit starts up printing of the consumables sales information in response to a printing command corresponding to a specified manual operation of the manual control unit.

3. The image-forming device according to claim 1 further comprising consumption detection unit that detects consumption of the consumables,
wherein the printing unit starts up printing of the consumables sales information in response to detection of consumption of the consumables by the consumption detection unit.

4. The image-forming device according to claim 1 further comprising an interface unit that communicates with a host device,
wherein the printing unit starts up printing of the consumables sales information in response to a printing request from the host device.

5. The image-forming device according to claim 1 further comprising an updating unit that updates the consumables sales information stored in the storage unit.

6. The image-forming device according to claim 5 further comprising an interface unit that communicates with a host device,
wherein the updating unit performs updating of the consumables sales information in response to a rewriting request from the host device.

7. The image-forming device according to claim 5 further comprising an interface unit that communicates with a host device,
wherein the updating unit performs updating of the consumables sales information using a dedicated application that runs on the host device.

8. The image-forming device according to claim 5 further comprising an interface unit that communicates with a dedicated tool,
wherein the updating unit performs updating of the consumables sales information using the dedicated tool.

9. The image-forming device according to claim 1 wherein the storage unit stores consumables sales information including name and contact details of a seller who sells the image-forming device, name of consumables to be sold, compatible device types, cost and sales advertising of the consumables to be sold.

10. The image-forming device according to claim 9 wherein the storage unit stores the consumables sales information including information notifying that a discount is available when purchasing the consumables.

11. The image-forming device according to claim 9 wherein the storage unit stores the consumables sales information including information regarding classification of the consumables that indicates new products, recycled products, high-performance products, small-capacity products or large-capacity products.

12. The image-forming device according to claim 1 wherein the storage unit stores consumables sales information including information as to the name and fax number of a seller who sells the image-forming device and order details of the consumables, the information being printed out onto the recording medium as consumables order document that is transmitted to the fax number of the seller.

13. A method of selling consumables in which a manufacturer manufactures an image-forming device and consumables used in the image-forming device, and a seller sells the image-forming device to a user and then sells to the user the consumables used in the image-forming device that the seller sold to the user,
wherein the manufacturer manufactures the image-forming device comprising a storage unit and a printing unit that prints out consumables sales information stored in the storage unit onto a recording medium;
the manufacturer or the seller stores the consumables sales information in the storage unit of the image-forming device; and
the seller sells to the user the image-forming device in which the consumables sales information is stored, receives an order for the consumables that is placed by the user who purchased the image-forming device in accordance with the consumables sales information printed out by the image-forming device, and sells to the user the consumables for which the order has been received.

14. The method of selling consumable products according to claim 13 wherein the manufacturer sells the storage unit of the image-forming device to the seller as an advertising space, stores in the storage unit consumables sales information relating to sale of the consumables by the seller who purchased the advertising space, and sells to the seller the image-forming device in which the consumables sales information is stored.

15. The method of selling consumables according to claim 13 wherein the manufacturer, on shipping the image-forming device to the seller, sells to the seller a dedicated tool that stores the consumables sales information in the storing means; and
the seller stores consumables sales information relating to sale by the seller of the consumables in the storage unit of the image-forming device shipped from the manufacturer, using the dedicated tool purchased from the manufacturer.

16. The method of selling consumables according to claim 13 wherein the consumables sales information includes name and contact details of a seller who sells the image-forming device in which the consumables sales information is stored, name of consumables to be sold, compatible device types and cost of the consumables to be sold.

17. The method of selling consumables according to claim 16 wherein the consumables sales information includes information notifying that a discount is available when purchasing the consumables.

18. The method of selling consumables according to claim 16 wherein the consumables sales information includes information regarding classification of the consumables indicating new products, recycled products, high-performance products, small-capacity products and large-capacity products.

19. The method of selling consumables according to claim 13 wherein the consumables sales information includes information on the name and fax number of the seller who sells the image-forming device in which the consumables sales information is stored and order details of the consumables, the information being printed out onto the recording medium as consumables order document that is transmitted to the fax number.
